(19) United States
(12) Patent Application Publication
(10) Pub. No.: US 2015/0242548 A1
(43) Pub. Date: Aug. 27, 2015

(54) SIMULATION OF PROGRAMMABLE LOGIC CONTROLLER INPUTS AND OUTPUTS

(71) Applicants: John David JONES, Johnson City, TN (US); Kellie CULP, Jonesborough, TN (US); Christopher Edward NOE, Jonesborough, TN (US)

(72) Inventors: John David Jones, Johnson City, TN (US); Kellie Culp, Jonesborough, TN (US); Christopher Edward Noe, Jonesborough, TN (US)

(73) Assignee: Siemens Aktiengesellschaft, Munchen (DE)

(21) Appl. No.: 14/430,567

(22) PCT Filed: Sep. 27, 2012
(86) PCT No.: PCT/US2012/057447

§ 371 Date: Mar. 24, 2015

(51) Int. Cl. G06F 17/50; G05B 19/05

(52) U.S. Cl. CPC G06F 17/5009; G05B 19/05

(57) ABSTRACT

The disclosed embodiments relate to simulation of one or more PLCs 302 which are to be physically implemented on conjunction with other devices 304 306, such as sensors or other devices 304 which provide information or signals to the PLC and/or actuators or other devices 306 which are controlled or otherwise receive information or signals from the PLC 302, e.g. to monitor and/or control various industrial machines or processes. The characteristics, physical or other attributes, of the interconnection(s) 308 between the PLC 302 and the other devices 304 306 are modeled 116 118 120 and simulated to ensure that the PLC 302 behaves in a manner consistent with the characteristics of the interconnection 308. Accordingly, using the disclosed embodiments, simulation of a PLC 302 will provide a more accurate representation of the expected actual operation thereof in the actual environment.

### BACKGROUND

A programmable logic controller (“PLC”), or programmable controller, is a digital computer used for automation of electromechanical processes, such as control of machinery or manufacturing equipment, such as on factory assembly lines, amusement rides, or light fixtures. PLCs are used in many industries and machines. Unlike general-purpose computers, a PLC is typically designed for multiple input and output arrangements and hardened for use in a hostile environment, such as an industrial environment, i.e. it may be designed for operation in extended temperature ranges, for immunity to electrical noise, and for resistance to vibration and impact. Programs to control machine operation are typically stored in battery-backed-up or non-volatile memory. A PLC is an example of a hard real time system since output results must be produced in response to input conditions within a limited time, otherwise unintended operation will result.

The main difference from other computers is that PLCs are typically armored for severe conditions (such as dust, moisture, heat, cold) and have the facility for extensive input/output (I/O) arrangements to connect, for example, to sensors and actuators. PLCs may be capable of reading limit switches, analog process variables (such as temperature and pressure), and the positions of complex positioning systems. Some PLCs may use machine vision and/or may operate electric motors, pneumatic or hydraulic cylinders, magnetic relays, solenoids, or analog outputs. The input/output arrangements may be built into a simple PLC, or the PLC may have external I/O modules, which may be referred to as “signal modules,” attached to a computer network that plugs into the PLC.

Modular PLCs may include a chassis (also called a rack) into which are placed modules with different functions. The processor and selection of I/O modules are customized for the particular application. Several racks may be administered by a single processor, and may have thousands of inputs and outputs. A communications medium, such as a special high speed serial I/O link, may be used so that racks can be distributed away from the processor, reducing the wiring costs for large plants.

Multiple PLCs may be used in environments, such as manufacturing environments, to control and coordinate multiple various machines involved in a particular process. This may require that the operations of the PLCs, which result in, or otherwise direct, the performance of the various operations by the manufacturing equipment, be coordinated or otherwise synchronized so that the appropriate steps of manufacturing processes are performed in the appropriate coordinate, temporal and/or sequential manner.

Generally, a PLC features input hardware, referred to as inputs, to which sensors or other devices may be connected. These inputs receive electrical signals from the connected devices and, in the case of an analog signal, digitize them, so that the control program running in the PLC can use them to make decisions. An analog input signal may be representative of a digital or binary value, e.g. an input voltage of 0 volts being off and 24 volts being on, wherein a sequence of voltage values received over time represent a sequence of binary values, e.g. data. The lid on a washing machine would be monitored in this manner. The lid can be open (off), or closed (on). The PLC within the washing machine would make decisions about what to do based on the position of the lid.

An analog input signal can also be representative of an analog value or value range, e.g. varying between 0 volts and a maximum value, again 24 volts for this example. In the PLC, the electrical input is digitized with an input of zero volts equating to an integer value of 0. As the voltage increases so does the integer value, an input of 12 volts might be converted to 16384 and 24 volts to 32767. This enables the PLC to make logical decisions based on magnitude. In the washing machine, the temperature setting might be set to medium-high. A temperature sensor would measure the temperature and send back an electrical signal based on temperature, perhaps 0 volts for 40 degrees and 12 volts for 120 degrees. When the input voltage has been digitized, the program in the PLC can compare it to the desired temperature and then send signals to open or close the hot and cold water valves appropriately to adjust the temperature of the water.

A PLC must be able to influence the world around it or it cannot control anything. A PLC controls its environment by sending electrical signals from its output interfaces. Outputs may be wired to actuators, valves, motors and other devices. The basic operation of an output is the same as an input, only reversed. Within the PLC program, a decision may be made to turn on something (digital), communicate information (digital) or change the output level of something (analog). The output is sent to hardware that generates the corresponding electrical signal(s). A digital output may turn on the beeper to alert the washing machine user that the load has completed. An analog signal might be sent to tell the motor on the washing machine how fast to run.

Input and output electrical signals can take on many forms. It may be a value that is voltage driven such as a signal from 0-24 volts. It may be direct current or alternating current. A signal may be in the form of current flow (0-20 milliamp). A signal may be a stream of pulses.

As the inputs from sensors as well as the outputs to controlled devices may be connected to the PLC using wires, how the PLC perceives and controls it's environment involves wires to transfer the electrical signals. Wires may be connected to sensors and actuators as previously discussed. Wires may be connected between two or more PLCs. Wires may be looped back from the outputs of a PLC to its own inputs, which is a common practice when testing PLCs and PLC programs.

### BRIEF SUMMARY

By way of introduction, the preferred embodiments described below include methods, systems, instructions, and computer readable media for providing a customized PLC to a customer.

In a first aspect, a method is provided for simulating operation of a programmable logic controller (“PLC”) 302, the PLC 302 having at least one input 310 for receiving an input signal 314 upon which at least a portion of the operation of the PLC 302 is based, the input signal 314 being received by the PLC 302 from a signal source 304 via an interconnection 308 coupled therebetween operative to convey the input signal 314. The method includes modeling, by a processor 102, operation of the PLC 302, including modeling the at least one input 310 thereof (Block 202); modeling, by the processor 102, at least a portion of operation of the interconnection 308 (Block 204); causing, by the processor 102, the interconnection model 118 to simulate at least a portion of operation of the modeled interconnection 308 to generate a simulated input signal to the at least one input of the PLC model 116 (Block 206); providing, by the processor 102, the simulated input signal to the at least one input of the PLC model 116 (Block 208); and causing, by the processor 102, the PLC model 116 to simulate operation of the associated modeled PLC 302, wherein at least a portion of the simulated operation is based on the simulated input signal generated by the interconnection model 118 (Block 210).

In a second aspect, a system is provided for simulation of operation of a programmable logic controller (“PLC”) 302, the PLC 302 having at least one input 310 for receiving an input signal 314 upon which at least a portion of the operation of the PLC 302 is based, the input signal 314 being received by the PLC 302 from a signal source 304 via an interconnection 308 coupled therebetween operative to convey the input signal 314. The system includes first logic 106 stored in a memory 104 and executable by a processor 102 to cause the processor 102 to model 116 operation of the PLC 302, including modeling of the at least one input thereof 310; second logic 108 stored in the memory 104 and executable by the processor 102 to cause the processor 102 to model 118 at least a portion of operation of the interconnection 308; third logic 110 stored in the memory 104 and executable by the processor 102 to cause the processor 102 to cause the interconnection model 118 to simulate at least a portion of operation of the modeled interconnection 308 to generate a simulated input signal to the at least one input of the PLC model 116; fourth logic 112 stored in the memory 104 and executable by the processor 102 to cause the processor 102 to provide the simulated input signal to the at least one input of the PLC model 116; and fifth logic 114 stored in the memory 104 and executable by the processor 102 to cause the processor 102 to cause the PLC model 116 to simulate operation of the associated modeled PLC 302, wherein at least a portion of the simulated operation is based on the simulated input signal generated by the interconnection model 118.

The present invention is defined by the following claims, and nothing in this section should be taken as a limitation on those claims. Further aspects and advantages of the invention are discussed below in conjunction with the preferred embodiments and may be later claimed independently or in combination.

### BRIEF DESCRIPTION OF THE DRAWINGS

FIG. 1 depicts a block diagram of a system for simulating operation of a programmable logic controller according to the disclosed embodiments.

FIG. 2 shows a flow chart depicting operation of the system of FIG. 1 according to one embodiment.

FIG. 3 shows an exemplary implementation of a PLC which may be simulated by the system of FIG. 1.

FIG. 4 shows a block diagram of a general computer system for use with the disclosed embodiments.

FIGS. 5-9 show process diagrams depicting exemplary operation of one implementation of the system of FIG. 1.

### DETAILED DESCRIPTION

The disclosed embodiments relate to simulation of one or more PLCs which are to be physically implemented in conjunction with other devices, such as sensors or other devices which provide information or signals to the PLC and/or actuators or other devices which are controlled or otherwise receive information or signals from the PLC, e.g. to monitor and/or control various industrial machines or processes. It will be appreciated that the other devices interconnected with the PLC may include another PLC and/or the PLC itself, i.e. with its outputs looped back to connect with its inputs. The characteristics, physical or other attributes, of the interconnection(s) between the PLC and the other devices are modeled and simulated to ensure that the PLC behaves in a manner consistent with the characteristics of the interconnection. Accordingly, using the disclosed embodiments, simulation of a PLC will provide a more accurate representation of the expected actual operation thereof in the actual environment. For example, simulation of the PLC will reflect delay in receiving a signal from sensor caused by the length of the interconnection therebetween, e.g. the PLC operation may thereby be delayed resulting in a delay in generating a control signal which may further delay a process or machine operation triggered thereby.

Accurate simulation of PLC operation can help in resolving defective operation, as well as creating better cost analysis and planning. When bidding on a job, it is often difficult to know what equipment is required due to unforeseen bottlenecks. It is also difficult to identify wasted resources. It is desirable that the implementation designer determine the necessary level of performance to achieve the desired functionality while minimizing unnecessary costs.

In addition, when utilizing multiple PLCs, sensor/measurement devices, and/or control devices, to monitor and control different portions of a coordinated manufacturing or other industrial process, it may be necessary to coordinate the operations of the PLC(s) to effect the desired coordinated implementation thereof. For example, on a manufacturing line which applies labels to containers, one would want to ensure that the machine which applies the label to the container is coordinated with the machine which feeds the containers thereto so that a container is positioned properly when the label is applied. As the different PLCs, sensors and control devices may be connected via, for example, different lengths of wire, asymmetric signal propagation delays among the different interconnections may result in race or other timing conditions where, for example, sensor readings from different sensors which should arrive at the PLC simultaneously, instead arrive at the PLC at different times resulting in unintended operation. This may therefore necessitate repeated testing to identify and make adjustments or otherwise tune the actual implementation to account for such discrepancies.

Anticipation/prediction of the need for such adjustments prior to implementation or when modifying an implementation may be difficult. Further, performance of these adjustments in a live manufacturing environment may be time consuming and inefficient and may result in wasted resources and lost revenue as the PLCs are appropriately adjusted and then tested to ensure satisfactory operation. In mission critical applications, the ability to test and tune may be severely limited.

Accordingly, simulation of the operation of the PLC(s) may be appropriate whereby computer models of the PLC(s) are created and operated in a computer simulated environment in order to demonstrate the expected operation and identify any problems. This may then allow any necessary adjustments to the actual implementation to be anticipated and accounted for prior to or during implementation, thereby reducing inefficiencies. Unfortunately, existing simulation systems do not model the interconnections which connect the PLC to other devices for input and output making it difficult to anticipate and implement the necessary operational adjustments. That is, when a PLC is simulated, the inputs would be provided in an ideal manner, thereby, for example, masking the potential need to adjust the operation of the PLC.

In particular, in a virtual or simulated PLC the hardware and firmware of a PLC is implemented, or modeled, using a computer program running on one or more host computers or processors, such as a desktop or laptop personal computer. The virtual PLC (VPLC) can load and execute a program designed to monitor and control its environment based on inputs. However, in the virtual environment there are no actual physical wires to bring signals to the VPLC, there is no hardware to convert these electrical signals to data the VPLC can use, there is no hardware to convert output data to electrical levels, and there are no wires to carry the outputs to the actuators or other PLCs.

The disclosed embodiments facilitate the simulation of virtual wires to interconnect the PLC(s) under simulation with other simulated devices or approximations thereof, as will be described.

In one embodiment, a mechanism for simulating a looping back of outputs to inputs of the same VPLC is provided. In particular, this mechanism loads a configuration file that defines each wire, specifying which output and which input to which the wire is attached. There are provision to handle the cases where multiple inputs are fed from one output and where multiple outputs feed one input.

In this implementation, a wire may be defined a bit width, i.e. a wire carrying an analog representation of a digital value may be 1 bit wide whereas a wire carrying an analog representation of an analog value may be 1-4 bytes wide to carry values from 0-255 or 0-4 billion. It will be appreciated that the defined width of the simulated interconnection, e.g. simulated wire or other medium, may be any number of bits necessary to represent the desired range or resolution of digital or analog values being carried over the interconnection. Further, it will be appreciated that whether representative of a digital or analog value, the actual signals carried are analog, i.e. voltage and/or current levels, RF frequencies or intensities, sonic frequencies or intensities, etc. Whereas a PLC may feature one or more analog to digital converters (“ADC”) or digital to analog converters (“DAC”) coupled with the inputs or outputs to convert analog signals to/from digital representations thereof, in a computer simulation environment, the signals may be provided to or generated by the PLC model in a digital form obviating the need to model the ADC/DAC functionality.

In one embodiment, logical operations may be applied to a simulated wire. For a digital wire, for example, the value on the wire may be inverted. For an analog wire, a logical operation such as adding an offset or performing AND/OR operations on the bits of the bytes can be performed.

Additional functionality provided by the disclosed embodiments may include, but is not limited to:
1. Simulation of virtual wire connection between two or more VPLCs;
2. Simulation of virtual wire connection between VPLCs and one or more sensors and/or actuators;
3. Time based manipulation of the simulated signal on the virtual wire such a delaying the propagation of a digital signal and/or ramping or hysteresis of an analog signal;
4. Injection of a positive or negative offset bias to the value on a simulated analog signal;
5. Simulation of wire breaks or intermittent connections; or
6. Injection of “noise” on the virtual wire such as electrostatic discharge or cross talk.

In one embodiment, virtual or simulated interconnections with a simulated PLC are defined using configuration data, which may be provided in the form of a data file, which is used to configure the simulated operation of an interconnection model. The configuration file may adhere to a defined format which may include, for example, rules for an I/O Mapping Format:

Each I/O mapping will be formatted as shown below:
So=xx, SSo=xx, OFo=x.x, L=x.x˜Si=xx, Ssi=xx, OFi=x.x
So=Output Slot
SSo=Output Subslot
OFo=Output Offset (Byte.Bit); Starting point
˜=Separates the output and length variables from the input variables
L=Length (Byte.Bit); (This value is the same for output and input)
Si=Input Slot
SSi=Input Subslot
OFi=Input Offset (Byte.Bit); Starting point

A slot is a device such as a communications module or signal board. A subslot is the bank of I/O in that device. An offset is the starting location within that subslot for the I/O mapping being defined.

An example of one I/O Mapping may be:
So=01, SSo=01, OFo=0.0, L=1.2˜Si=01, SSi=01, OFi=0.0

This means that the output for this mapping is located on slot 01, subslot 01. The input for this mapping is located on slot 01, subslot 01. Starting at output byte 0, bit 0 (defined by output offset), 10 consecutive bits (length specified is 1 byte+2 bits=10 bits) are mapped to 10 consecutive input points starting at input byte 0, bit 0 (defined by input offset). This means output byte 0, bit 0 is mapped to input byte 0, bit 0; output byte 0, bit 1 is mapped to input byte 0, bit 1, etc. This mapping pattern continues for a length of 10 bits, so the last two points that are wired together would be output byte 1, bit 1 to input byte 1, bit 1.

Each group of consecutively mapped I/O points should be on a separate line and formatted as described above. Below is an example of a wiring file that has 3 groups of consecutively mapped I/O points.
So=01, SSo=01, OFo=0.0, L=1.2˜Si=01, SSi=01, OFi=0.0
So=01, SSo=01, OFo=0.0, L=0.4˜Si=01, SSi=01, OFi=1.2
So=01, SSo=03, OFo=0.0, L=0.2˜Si=01, SSi=03, OFi=0.0

In one implementation of the described configuration file, outputs wired to multiple inputs have 2 entries—1 for each input. An output point that is mapped to 2 different input points should have 2 entries as shown in the example below.
So=01, SSo=01, OFo=0.0, L=1.2˜Si=01, SSi=01, OFi=0.0
So=01, SSo=01, OFo=0.0, L=0.4˜Si=01, SSi=01, OFi=1.2

Here, output points 0.0-1.1 are mapped to input points 0.0-1.1 in the first entry. The second entry shows that output points 0.0-0.3 are also mapped to input points 1.2-1.5.

The defined configuration file format may further include rules for slot and subslot numbers:
CPU always-->Slot 1,
OB Digital IO-->Slot 01, SubSlot 01
OB Analog IO-->Slot 01, SubSlot 02
SB IO-->Slot 01, SubSlot 03
Signal Module(s) (“SM”)-->Starts at Slot 02 and proceeds up, Maximum of Slot 09 (Maximum 8 SMs)
   Note: SubSlot always 01, because no other subslots can exist for SM
Communications Module(s) (“CM”)-->Starts at Slot 101 and proceed up, Maximum of Slot 103 (Maximum 3 CMs)
   Note: SubSlot always 01, because no other subslots can exist for CM

Various method for creating or otherwise defining a wiring setup may be provided:
1. Creating a Wiring Setup via Loading a File:
   Each I/O mapping in a file should be on a separate line and formatted as described above. The file should be saved as a text file.
   For example:
   So=01, SSo=01, OFo=0.0, L=1.2˜Si=01, SSi=01, OFi=0.0
   So=01, SSo=01, OFo=0.0, L=0.4˜Si=01, SSi=01, OFi=1.2
   So=01, SSo=03, OFo=0.0, L=0.2˜Si=01, SSi=03, OFi=0.0
   The wiring can be created from this file using a LoadConfigFromFile function in a Simulator class. For example:
      sim.LoadConfigFromFile(“configfile.txt”);
2. Creating a Wiring Setup via an array of strings:
   Each I/O mapping may be in a different index of the array. The wiring is created by calling a LoadConfig function of the Simulator class and passing this array to it. For example:
      sim.LoadConfig(wiringArray);
3. Creating a Wiring Setup via a string:
   The string should contain a single I/O mapping. The wiring is created by calling a LoadConfig function of a Simulator class and passing this string to it. For example:
      sim.LoadConfig(“So=01, SSo=01, OFo=0.0, L=1.2˜Si=01, SSi=01, OFi=0.”);

Herein, the phrase “coupled with” is defined to mean directly connected to or indirectly connected through one or more intermediate components. Such intermediate components may include both hardware and software based components. Further, to clarify the use in the pending claims and to hereby provide notice to the public, the phrases “at least one of <A>, <B>, . . . and <N>” or “at least one of <A>, <B>, . . . <N>, or combinations thereof” are defined by the Applicant in the broadest sense, superseding any other implied definitions herebefore or hereinafter unless expressly asserted by the Applicant to the contrary, to mean one or more elements selected from the group comprising A, B, . . . and N, that is to say, any combination of one or more of the elements A, B, . . . or N including any one element alone or in combination with one or more of the other elements which may also include, in combination, additional elements not listed.

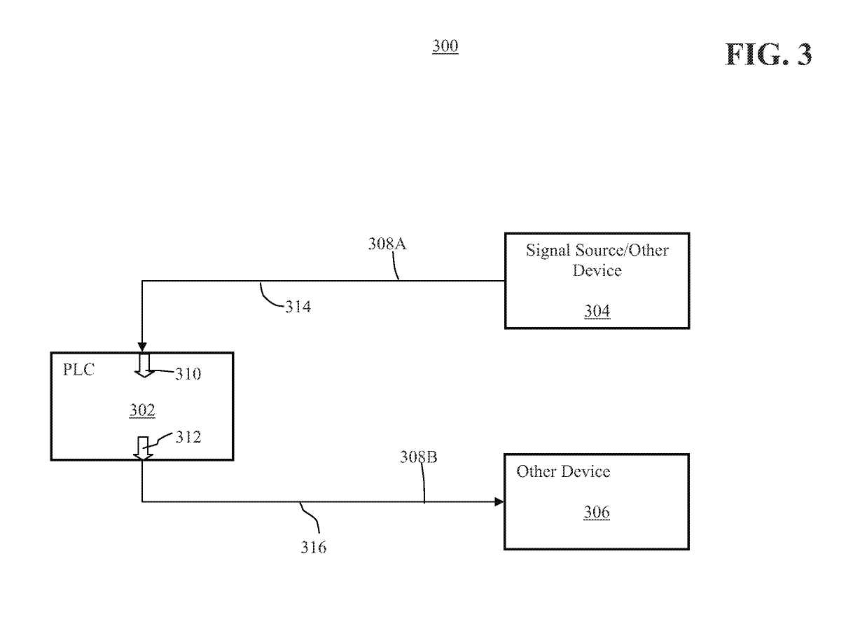

FIG. 3 shows an exemplary implementation 300 of a PLC 302 having one or more inputs 310 and outputs 312. An exemplary PLC 302 which may be simulated by the disclosed embodiments is the Siemens S7-1200 CPU 1215C, manufactured by Siemens Aktiengesellschaft, Munich, Germany. The PLC 302 may be deployed in conjunction with one or more input devices 304, such as sensors, switches, or other devices, such as other PLCs, which may send analog or digital signals 314 to an input 310 of the PLC 302 via the interconnection 308A. Further, the PLC 302 may be deployed in conjunction with one or more output devices 306, such as actuators, indicators, control devices, or other devices, including other PLCs, which may receive analog or digital signals 316 from an output 312 of the PLC 302 via the interconnection 308B. It will be appreciated that a single device may be both an input 304 and an output device 306 and may be the PLC 302 itself when configured, for example, in a loop back configuration whereby one or more inputs 310 are coupled with one or more outputs 312 of the PLC 302. The interconnection 308 may be one or more wires, such as copper or aluminum wires, cables, optical fibers, or other physical medium linking the PLC 302 with the input 304 or output device 306 and include other devices such as amplifiers, repeaters or other intervening devices (not shown) through which a signal being communicated between the PLC 302 and devices 304, 306 must pass. It will be appreciated that the interconnection(s) 308 may be implemented by any medium including a wireless medium such as radio frequency (“RF”), optical or sound based medium.

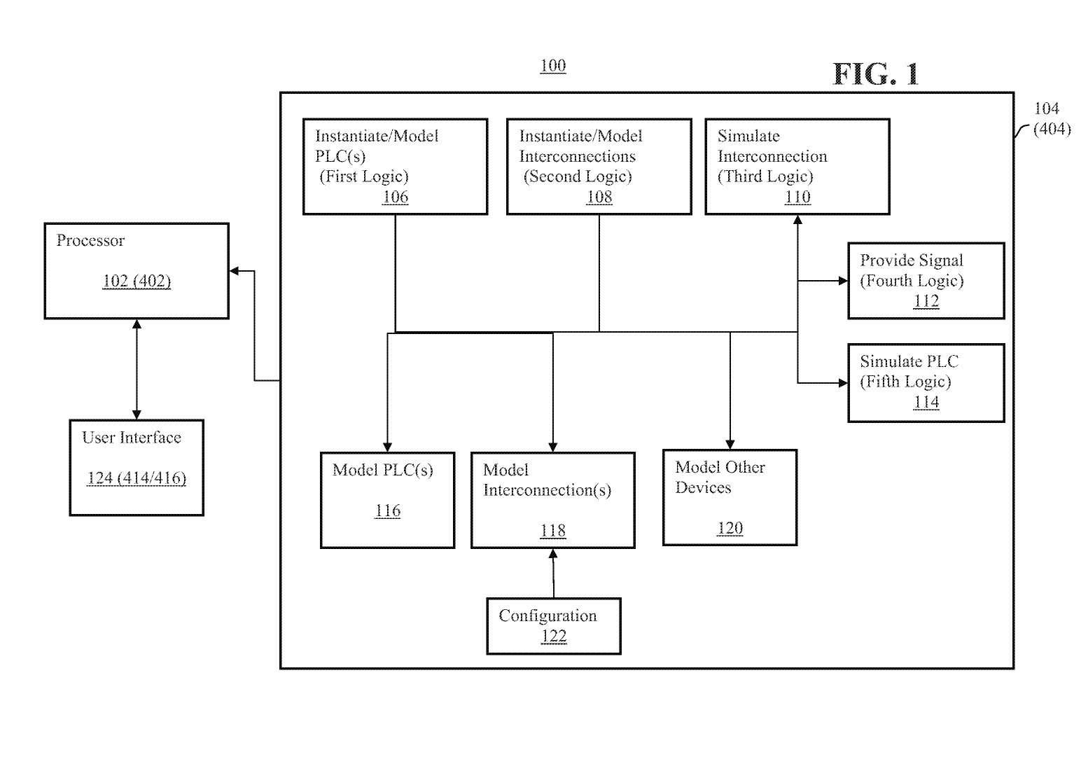

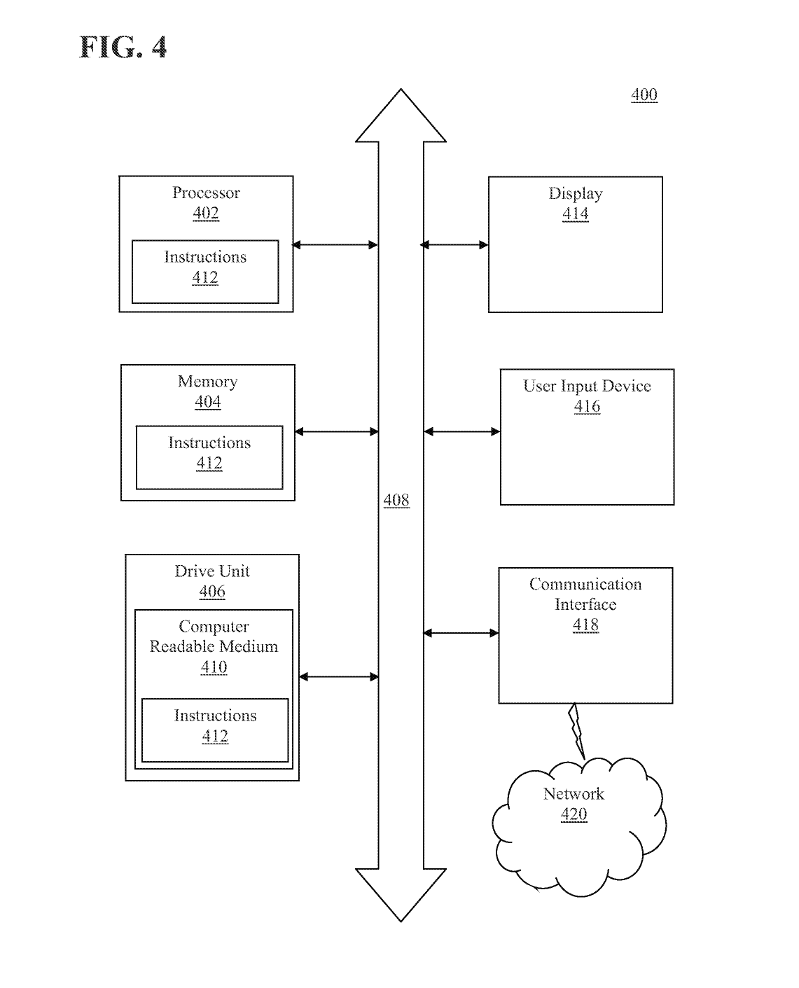

FIG. 1 shows a block diagram of a system 100 for simulation of operation of a programmable logic controller (“PLC”) 302, the PLC 302 having at least one input 310 for receiving an input signal 314 upon which at least a portion of the operation of the PLC 302 is based, the input signal 314 being received by the PLC 302 from a signal source 304, such as a sensor, other PLC, etc., via an interconnection 308, such as one or more wires, coupled therebetween operative to convey the input signal 314. It will be appreciated that the simulation system 100 may be implemented in one or more computing devices, such as the computing device 400 described below with respect to FIG. 4. While exemplary embodiments will be describe herein with respect to a single processor 102 coupled with a single memory 104, which may be implemented using the processor 402 and memory 404 described below with respect to FIG. 4, it will be appreciated that the disclosed embodiments may be implemented in a loosely or tightly coupled multiprocessor and or multi-memory system. Further, while the disclosed simulation control logic is described as being stored in the same memory in which the modeled PLC(s) and interconnection(s) are instantiated, it will be appreciated that the modeled PLC(s) and interconnection(s) may be instantiated in a separate memory or in a separate computer system controlled by a separate processor. For example, dedicated simulation computer systems may be provided for executing the PLC simulation models under the control a separate control system.

Referring back to FIG. 1, in the exemplary embodiment, the system 100 includes first logic 106 stored in a memory 104 and executable by a processor 102 to cause the processor 102 to instantiate or otherwise model 116 operation of the PLC 302, including modeling of the at least one input thereof 310 or at least a portion thereof. It will be appreciated that, as described above, the modeling of the at least one input 310 may not include modeling operation of an ADC which may be implemented thereby. As described, the simulated PLC may be instantiated in the same or a different memory as the first logic 106. The system 100 may further include a user interface 124, such as the user interface 414/416 described below with respect to FIG. 4, for receiving instructions or commands from a user, such as commands to instantiate PLC models 116, initiate a simulation as described herein, or provide data such as the interconnection configuration parameters 122 described elsewhere herein, and provide output to the user, such as results of the simulation.

The system 100 further includes second logic 108 stored in the memory 104 and executable by the processor 102 to cause the processor 102 to model 118 at least a portion of operation of the interconnection 308.

The system 100 further includes third logic 110 stored in the memory 104 and executable by the processor 102 to cause the processor 102 to cause the interconnection model 118 to simulate at least a portion of operation of the modeled interconnection 308 to generate a simulated input signal to the at least one input of the PLC model 116.

In one embodiment, wherein the PLC 302 further comprises at least one output 312 for transmission of an output signal 316, the first logic 106 being further executable by the processor 102 to cause the processor 102 to model the at least one output 312 thereof, the third logic 110 being further executable by the processor 102 to cause the processor 102 to receive a simulated output signal from the at least one output of the PLC model 116, generated during simulated operation of the associated modeled PLC 302, by the interconnection model 118, the simulated input signal being generated based thereon. In this manner, a loop back configuration, whereby one or more outputs 312 of the PLC 302 may be connected back to one or more of the inputs 310 of the PLC 302, may be simulated, such as for testing purposes.

Alternatively, or in addition thereto, the third logic 110 may be further executable by the processor 102 to cause the processor 102 to receive a simulated output signal from another device model 120, generated during simulated operation of the associated other modeled device 304, by the interconnection model 118, the simulated input signal being generated based thereon. Other device models 120 may include models of another PLC, a sensor or other device, or combination thereof, 304 which transmits signals to the PLC 302 via the interconnection 308.

The system 100 further includes fourth logic 112 stored in the memory 104 and executable by the processor 102 to cause the processor 102 to provide the simulated input signal to the at least one input of the PLC model 116.

The system 100 further includes fifth logic 114 stored in the memory 104 and executable by the processor 102 to cause the processor 102 to cause the PLC model 116 to simulate operation of the associated modeled PLC 302, wherein at least a portion of the simulated operation is based on the simulated input signal generated by the interconnection model 118

In one embodiment, the simulated input signal may include a representation of an analog signal conveying an analog value, such as a measured value within a range. It will be appreciated that the simulated input signal may be further characterized by a bit width or word length which may be based on number of binary digits necessary to represent the possible range, accuracy or resolution/granularity of values to be conveyed.

Alternatively, or in addition thereto, the simulated input signal may include a representation of an analog signal conveying a digital value It will be appreciated that the simulated input signal may be further characterized by a bit width or word length which may be based on number of binary digits necessary to represent the possible range, accuracy or resolution/granularity of values to be conveyed.

In one embodiment, the simulated input signal may include a representation of an effect on the input signal 314 caused by an electrical characteristic of the modeled interconnection 308 comprising, for example, a resistance, capacitance, impedance, inductance, reactance, a change or rate of change thereof, or combinations thereof. Other effects may also be simulated, such as thermal effects due to temperature and/or humidity, or changes therein, humidity, effects due to mechanical wear, or physical position, or changes therein, or other physical characteristics of the interconnection 308, such as length, thickness, e.g. gauge, material or composition thereof.

In on embodiment, the simulated input signal may include a representation of an effect on the input signal 314 caused by a characteristic of the modeled interconnection 308 comprising, for example, latency, interference (intermittent or constant), noise (such as due to cross talk or nearby machinery, delay, or combinations thereof.

It will be appreciated that any characteristic of the interconnection 308 which may affect the propagation of a signal thereover may be simulated by the system 100.

In one embodiment, the simulated input signal may include a pattern, such as a ramp in magnitude or frequency, a sequence, an alternation, a sinusoidal, a saw tooth, a step, linear, non-linear or other function based pattern or combination thereof.

In one embodiment, as described above, the interconnection model 120 may include or otherwise be responsive to at least one configuration parameter 122, such as may be provided in a configuration file, the simulated input signal being generated based thereon. This configuration parameter may define mapping between a source of the simulated signal, such as an output 312 or other device 306 from which it is derived and a sink/destination for the simulated signal, such as an input 310 or other device to which the simulated signal is to be provided. For example, the mapping may define a loopback configuration as described above. The configuration parameter(s) may further specify characteristics of the interconnection 308 to be applied to the simulated signal, as described above, including electrical characteristics, mechanical characteristic or other simulated adjustments thereto.

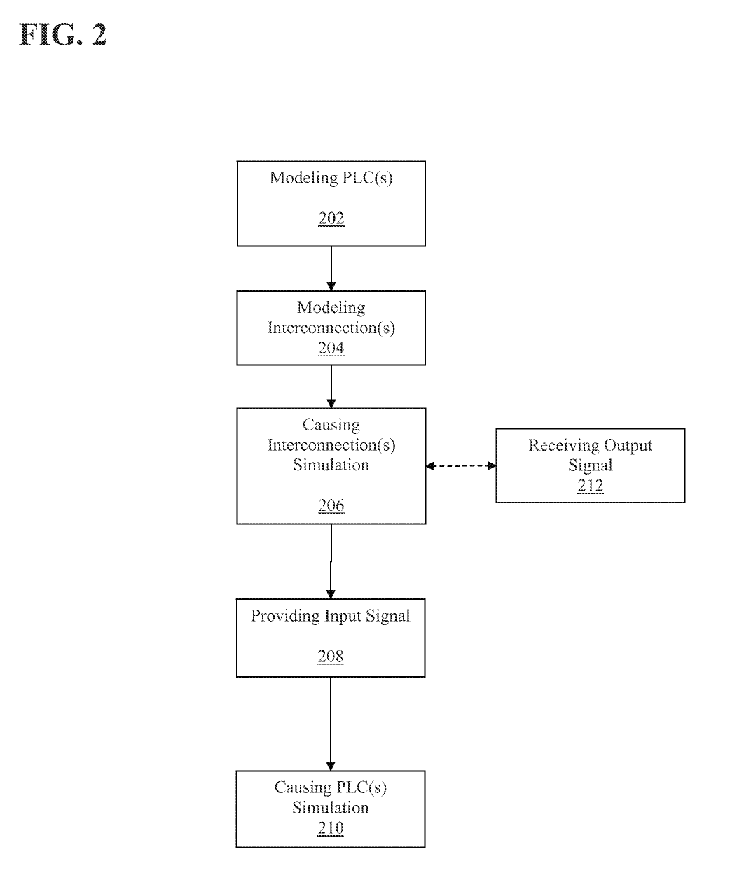

FIG. 2 depicts a flow chart showing operation of the system 100 of FIG. 1 for simulating operation of a programmable logic controller (“PLC”) 302, the PLC 302 having at least one input 310 for receiving an input signal 314 upon which at least a portion of the operation of the PLC 302 is based, the input signal 314 being received by the PLC 302 from a signal source 304, such as a sensor, another PLC or the output of the PLC 302, via an interconnection 308, e.g. one or more wires, coupled therebetween operative to convey the input signal 314. In particular, the operation includes: modeling, by a processor 102, operation of the PLC 302, including modeling the at least one input 310 thereof, or at least a portion thereof (Block 202); modeling, by the processor 102, at least a portion of operation of the interconnection 308 (Block 204); causing, by the processor 102, the interconnection model 118 to simulate at least a portion of operation of the modeled interconnection 308 to generate a simulated input signal to the at least one input of the PLC model 116 (Block 206); providing, by the processor 102, the simulated input signal to the at least one input of the PLC model 116 (Block 208); and causing, by the processor 102, the PLC model 116 to simulate operation of the associated modeled PLC 302, wherein at least a portion of the simulated operation is based on the simulated input signal generated by the interconnection model 118 (Block 210).

In one embodiment, wherein the PLC 302 further comprises at least one output 312 for transmitting an output signal 316, the modeling of the operation of the PLC 302 further comprising modeling the at least one output 312 thereof, the causing of the interconnection model 118 to simulate operation of the modeled interconnection 308 further comprising receiving a simulated output signal from the at least one output of the PLC model 116 during simulated operation of the associated modeled PLC 302 by the interconnection model 118, the simulated input signal being generated based thereon (Block 212).

In one embodiment, wherein the causing of the interconnection model 118 to simulate operation of the modeled interconnection 308 further comprises receiving a simulated output signal from another device model 120, generated during simulated operation of the associated other modeled device 304, by the interconnection model 118, the simulated input signal being generated based thereon (Block 212). As described above, the other device model 120 may include a model of another PLC, a sensor, or combinations thereof 304.

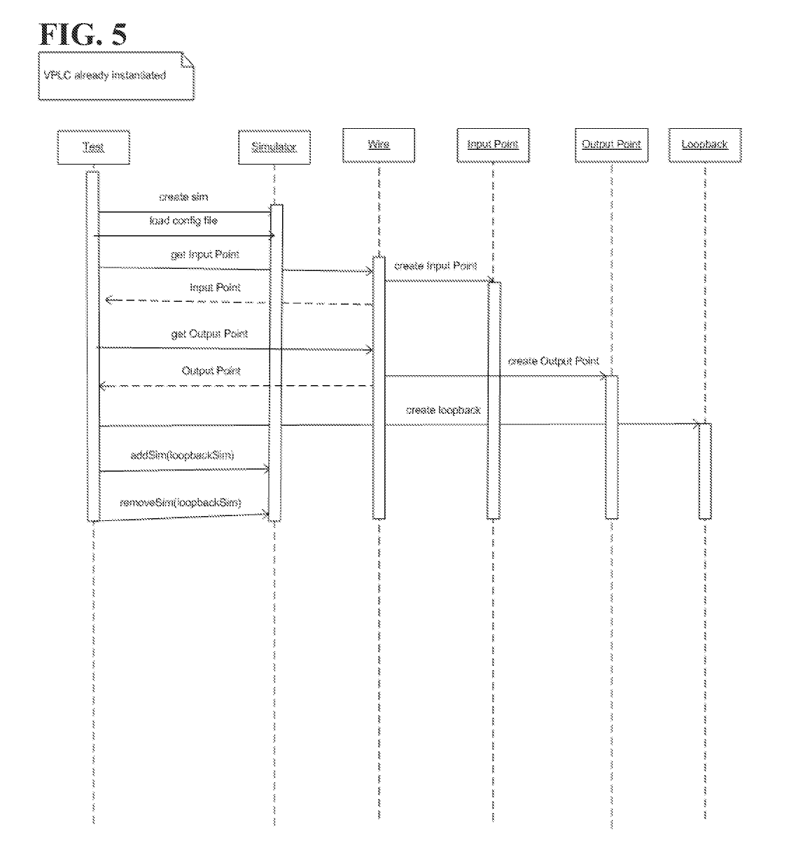

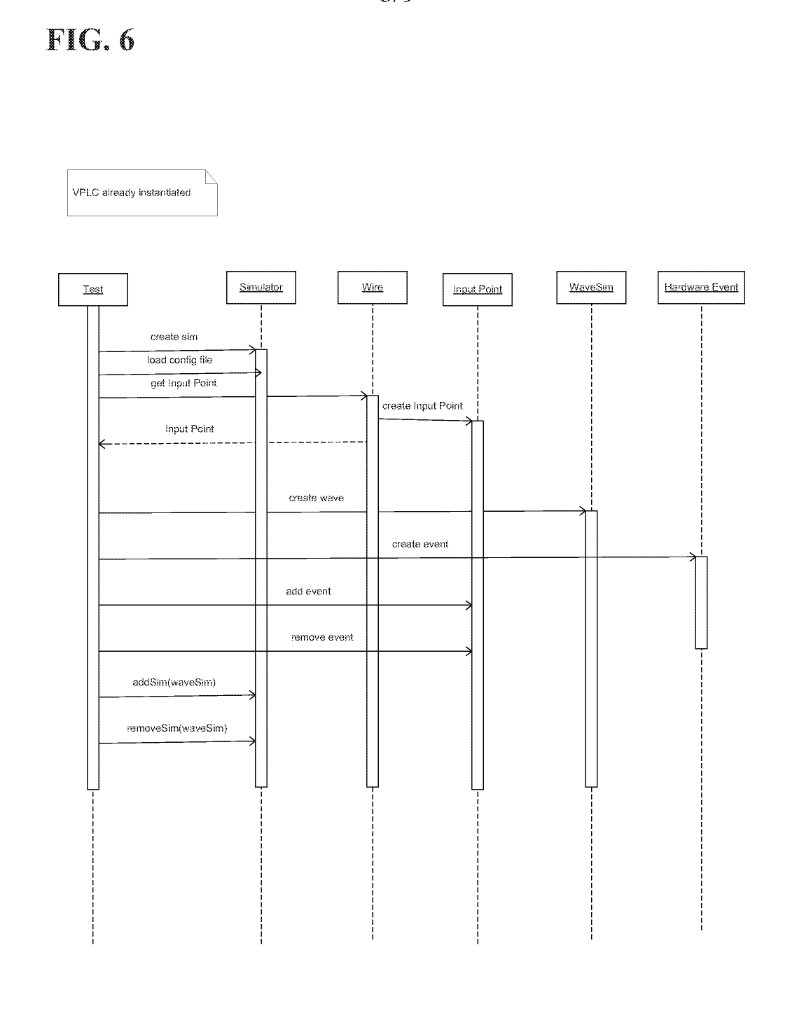

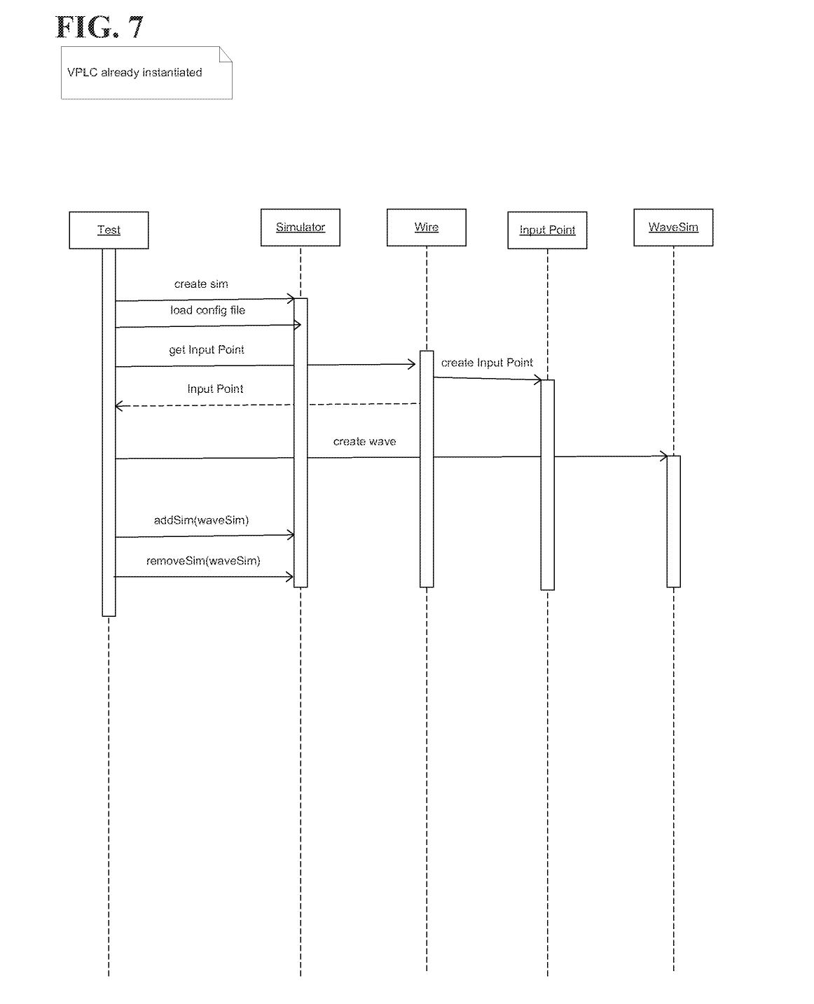

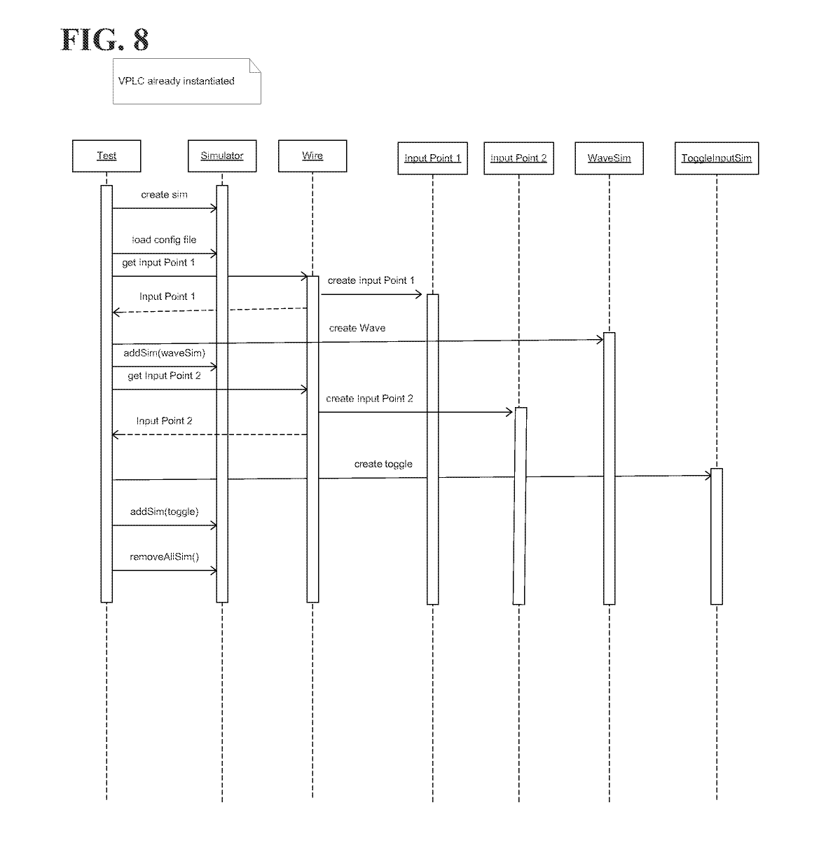

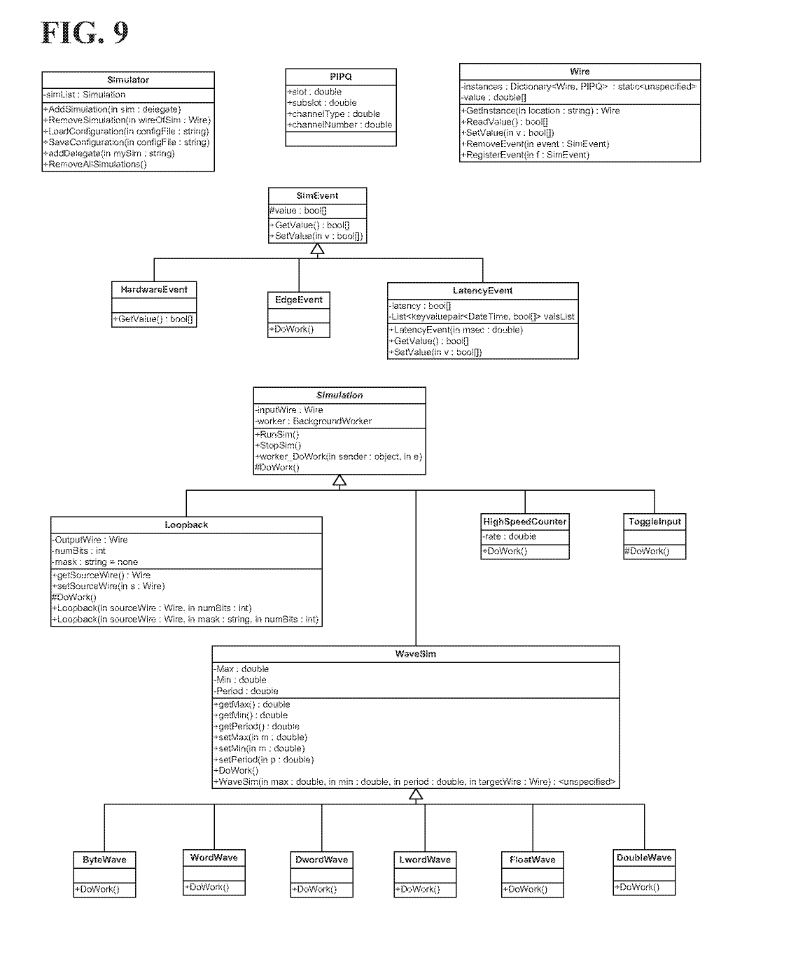

FIGS. 5-9 depict process diagrams showing exemplary operation of one implementation of the disclosed system 100. FIG. 5 shows a process diagram depicting a process for creating and then destroying a simulated loopback. In the sequence depicted in FIG. 5, an output is looped back to an input on the same PLC. FIG. 6 shows a process diagram depicting a process for creating or removing a simulation of a hardware event. FIG. 7 shows a process diagram depicting a process for adding a waveform simulation. FIG. 8 shows a process diagram depicting a process for adding and removing multiple concurrent simulation types. FIG. 9 shows a process diagram depicting an exemplary class diagram of one implementation of the disclosed system 100.

One skilled in the art will appreciate that one or more components described herein may be implemented using, among other things, a tangible computer-readable medium comprising computer-executable instructions (e.g., executable software code). Alternatively, modules may be implemented as software code, firmware code, hardware, and/or a combination of the aforementioned. For example the modules may be embodied as part of a programmable logic controller as described above.

Referring to FIG. 4, an illustrative embodiment of a general computer system 400 is shown. The computer system 400 can include a set of instructions that can be executed to cause the computer system 400 to perform any one or more of the methods or computer based functions disclosed herein. The computer system 400 may operate as a standalone device or may be connected, e.g., using a network, to other computer systems or peripheral devices. Any of the components discussed above, such as the PLC 100 or a component thereof, may be a computer system 400 or a component in the computer system 400. The computer system 400 may implement a programmable logic controller, of which the disclosed embodiments are a component thereof.

In a networked deployment, the computer system 400 may operate in the capacity of a server or as a client user computer in a client-server user network environment, or as a peer computer system in a peer-to-peer (or distributed) network environment. The computer system 400 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 400 can be implemented using electronic devices that provide voice, video or data communication. Further, while a single computer system 400 is illustrated, the term “system” shall also be taken to include any collection of systems or sub-systems that individually or jointly execute a set, or multiple sets, of instructions to perform one or more computer functions.

As illustrated in FIG. 4, the computer system 400 may include a processor 402, e.g., a central processing unit (CPU), a graphics processing unit (GPU), or both. The processor 402 may be a component in a variety of systems. For example, the processor 402 may be part of a standard personal computer or a workstation. The processor 402 may be one or more general processors, digital signal processors, application specific integrated circuits, field programmable gate arrays, servers, networks, digital circuits, analog circuits, combinations thereof, or other now known or later developed devices for analyzing and processing data. The processor 402 may implement a software program, such as code generated manually (i.e., programmed).

The computer system 400 may include a memory 404 that can communicate via a bus 408. The memory 404 may be a main memory, a static memory, or a dynamic memory. The memory 404 may include, but is not limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one embodiment, the memory 404 includes a cache or random access memory for the processor 402. In alternative embodiments, the memory 404 is separate from the processor 402, such as a cache memory of a processor, the system memory, or other memory. The memory 404 may be an external storage device or database for storing data. Examples include a hard drive, compact disc (“CD”), digital versatile disc (“DVD”), memory card, memory stick, floppy disc, universal serial bus (“USB”) memory device, or any other device operative to store data. The memory 404 is operable to store instructions executable by the processor 402. The functions, acts or tasks illustrated in the figures or described herein may be performed by the programmed processor 402 executing the instructions 412 stored in the memory 404. The functions, acts or tasks are independent of the particular type of instructions set, storage media, processor or processing strategy and may be performed by software, hardware, integrated circuits, firmware, micro-code and the like, operating alone or in combination. Likewise, processing strategies may include multiprocessing, multitasking, parallel processing and the like.

As shown, the computer system 400 may further include a display unit 414, such as a liquid crystal display (LCD), an organic light emitting diode (OLED), a flat panel display, a solid state display, a cathode ray tube (CRT), a projector, a printer or other now known or later developed display device for outputting determined information. The display 414 may act as an interface for the user to see the functioning of the processor 402, or specifically as an interface with the software stored in the memory 404 or in the drive unit 406.

Additionally, the computer system 400 may include an input device 416 configured to allow a user to interact with any of the components of system 400. The input device 416 may be a number pad, a keyboard, or a cursor control device, such as a mouse, or a joystick, touch screen display, remote control or any other device operative to interact with the system 400.

In a particular embodiment, as depicted in FIG. 4, the computer system 400 may also include a disk or optical drive unit 406. The disk drive unit 406 may include a computer-readable medium 410 in which one or more sets of instructions 412, e.g. software, can be embedded. Further, the instructions 412 may embody one or more of the methods or logic as described herein. In a particular embodiment, the instructions 412 may reside completely, or at least partially, within the memory 404 and/or within the processor 402 during execution by the computer system 400. The memory 404 and the processor 402 also may include computer-readable media as discussed above.

The present disclosure contemplates a computer-readable medium that includes instructions 412 or receives and executes instructions 412 responsive to a propagated signal, so that a device connected to a network 420 can communicate voice, video, audio, images or any other data over the network 420. Further, the instructions 412 may be transmitted or received over the network 420 via a communication interface 418. The communication interface 418 may be a part of the processor 402 or may be a separate component. The communication interface 418 may be created in software or may be a physical connection in hardware. The communication interface 418 is configured to connect with a network 420, external media, the display 414, or any other components in system 400, or combinations thereof. The connection with the network 420 may be a physical connection, such as a wired Ethernet connection or may be established wirelessly as discussed below. Likewise, the additional connections with other components of the system 400 may be physical connections or may be established wirelessly.

The network 420 may include wired networks, wireless networks, or combinations thereof. The wireless network may be a Modbus network, cellular telephone network, an 802.11, 802.16, 802.20, or WiMax network. Further, the network 420 may be a public network, such as the Internet, a private network, such as an intranet, or combinations thereof, and may utilize a variety of networking protocols now available or later developed including, but not limited to TCP/IP based networking protocols.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a computer readable medium for execution by, or to control the operation of, data processing apparatus. While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein. The computer readable medium can be a machine-readable storage device, a machine-readable storage substrate, a memory device, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP, HTTPS) represent examples of the state of the art. Such standards are periodically superseded by faster or more efficient equivalents having essentially the same functions. Accordingly, replacement standards and protocols having the same or similar functions as those disclosed herein are considered equivalents thereof.

A computer program (also known as a program, software, software application, script, or code) can be written in any form of programming language, including compiled or interpreted languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a device having a display, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings and described herein in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

It is therefore intended that the foregoing detailed description be regarded as illustrative rather than limiting, and that it be understood that it is the following claims, including all equivalents, that are intended to define the spirit and scope of this invention.

What is claimed is:

1. A computer implemented method of simulating operation of a programmable logic controller (“PLC”) 302, the PLC 302 having at least one input 310 for receiving an input signal 314 upon which at least a portion of the operation of the PLC 302 is based, the input signal 314 being received by the PLC 302 from a signal source 304 via an interconnection 308 coupled therebetween operative to convey the input signal 314, the method comprising:
modeling, by a processor 102, operation of the PLC 302, including modeling the at least one input 310 thereof (Block 202);
modeling, by the processor 102, at least a portion of operation of the interconnection 308 (Block 204);
causing, by the processor 102, the interconnection model 118 to simulate at least a portion of operation of the modeled interconnection 308 to generate a simulated input signal to the at least one input of the PLC model 116 (Block 206);
providing, by the processor 102, the simulated input signal to the at least one input of the PLC model 116 (Block 208); and
causing, by the processor 102, the PLC model 116 to simulate operation of the associated modeled PLC 302, wherein at least a portion of the simulated operation is based on the simulated input signal generated by the interconnection model 118 (Block 210).

2. The computer implemented method of claim 1 wherein the PLC 302 further comprises at least one output 312 for transmitting an output signal 316, the modeling of the operation of the PLC 302 further comprising modeling the at least one output 312 thereof, the causing of the interconnection model 118 to simulate operation of the modeled interconnection 308 further comprising receiving a simulated output signal from the at least one output of the PLC model 116 during simulated operation of the associated modeled PLC 302 by the interconnection model 118, the simulated input signal being generated based thereon (Block 212).

3. The computer implemented method of claim 1 wherein the causing of the interconnection model 118 to simulate operation of the modeled interconnection 308 further comprises receiving a simulated output signal from another device model 120, generated during simulated operation of the associated other modeled device 304, by the interconnection model 118, the simulated input signal being generated based thereon (Block 212).

4. The computer implemented method of claim 3 wherein the other device model 120 comprises a model of another PLC, a sensor, or combinations thereof 304.

5. The computer implemented method of claim 1 wherein the simulated input signal comprises a representation of an analog signal conveying an analog value.

6. The computer implemented method of claim 1 wherein the simulated input signal comprises a representation of an analog signal conveying a digital value.

7. The computer implemented method of claim 1 wherein the simulated input signal comprises a representation of an effect on the input signal 314 caused by an electrical characteristic of the modeled interconnection 308 comprising a resistance, capacitance, impedance, inductance, reactance, a change or rate of change thereof, or combinations thereof.

8. The computer implemented method of claim 1 wherein the simulated input signal comprises a representation of an effect on the input signal 314 caused by a characteristic of the modeled interconnection 308 comprising latency, interference, noise, delay, or combinations thereof.

9. The computer implemented method of claim 1 wherein the simulated input signal comprises a pattern.

10. The computer implemented method of claim 1 wherein the interconnection model 120 comprises at least once configuration parameter 122, the simulated input signal being generated based thereon.

11. A system 100 for simulation of operation of a programmable logic controller (“PLC”) 302, the PLC 302 having at least one input 310 for receiving an input signal 314 upon which at least a portion of the operation of the PLC 302 is based, the input signal 314 being received by the PLC 302 from a signal source 304 via an interconnection 308 coupled therebetween operative to convey the input signal 314, the system 100 comprising:
first logic 106 stored in a memory 104 and executable by a processor 102 to cause the processor 102 to model 116 operation of the PLC 302, including modeling of the at least one input thereof 310;
second logic 108 stored in the memory 104 and executable by the processor 102 to cause the processor 102 to model 118 at least a portion of operation of the interconnection 308;
third logic 110 stored in the memory 104 and executable by the processor 102 to cause the processor 102 to cause the interconnection model 118 to simulate at least a portion of operation of the modeled interconnection 308 to generate a simulated input signal to the at least one input of the PLC model 116;
fourth logic 112 stored in the memory 104 and executable by the processor 102 to cause the processor 102 to provide the simulated input signal to the at least one input of the PLC model 116; and
fifth logic 114 stored in the memory 104 and executable by the processor 102 to cause the processor 102 to cause the PLC model 116 to simulate operation of the associated modeled PLC 302, wherein at least a portion of the simulated operation is based on the simulated input signal generated by the interconnection model 118.

12. The system of claim 11 wherein the PLC 302 further comprises at least one output 312 for transmission of an output signal 316, the first logic 106 being further executable by the processor 102 to cause the processor 102 to model the at least one output 312 thereof, the third logic 110 being further executable by the processor 102 to cause the processor 102 to receive a simulated output signal from the at least one output of the PLC model 116, generated during simulated operation of the associated modeled PLC 302, by the interconnection model 118, the simulated input signal being generated based thereon.

13. The system of claim 11 wherein the third logic 110 is further executable by the processor 102 to cause the processor 102 to receive a simulated output signal from another device model 120, generated during simulated operation of the associated other modeled device 304, by the interconnection model 118, the simulated input signal being generated based thereon.

14. The system of claim 13 wherein the other device model 120 comprises a model of another PLC, a sensor, or combinations thereof 304.

15. The system of claim 11 wherein the simulated input signal comprises a representation of an analog signal conveying an analog value.

16. The system of claim 11 wherein the simulated input signal comprises a representation of an analog signal conveying a digital value.

17. The system of claim 11 wherein the simulated input signal comprises a representation of an effect on the input signal 314 caused by an electrical characteristic of the modeled interconnection 308 comprising a resistance, capacitance, impedance, inductance, reactance, a change or rate of change thereof, or combinations thereof.

18. The system of claim 11 wherein the simulated input signal comprises a representation of an effect on the input signal 314 caused by a characteristic of the modeled interconnection 308 comprising latency, interference, noise, delay, or combinations thereof.

19. The system of claim 11 wherein the simulated input signal comprises a pattern.

20. The system of claim 11 wherein the interconnection model 120 comprises at least once configuration parameter 122, the simulated input signal being generated based thereon.

21. A system 100 for simulation of operation of a programmable logic controller (“PLC”) 302, the PLC 302 having at least one input 310 for receiving an input signal 314 upon which at least a portion of the operation of the PLC 302 is based, the input signal 314 being received by the PLC 302 from a signal source 304 via an interconnection 308 coupled therebetween operative to convey the input signal 314, the system 100 comprising:
means for modeling operation of the PLC 302, including modeling the at least one input 310 thereof;
means for modeling at least a portion of operation of the interconnection 308;
means for causing the interconnection model 118 to simulate at least a portion of operation of the modeled interconnection 308 to generate a simulated input signal to the at least one input of the PLC model 116;
means for providing the simulated input signal to the at least one input of the PLC model 116; and
means for causing the PLC model 116 to simulate operation of the associated modeled PLC 302, wherein at least a portion of the simulated operation is based on the simulated input signal generated by the interconnection model 118.
